(19) United States
(12) Patent Application Publication
(10) Pub. No.: US 2024/0302634 A1
(43) Pub. Date: Sep. 12, 2024

(54) OPTICAL SYSTEM, DISTANCE MEASUREMENT DEVICE INCLUDING THE SAME, AND ON-BOARD SYSTEM

(71) Applicant: CANON KABUSHIKI KAISHA, Tokyo (JP)

(72) Inventor: NAOTO DOUJOU, Tochigi (JP)

(21) Appl. No.: 18/667,759

(22) Filed: May 17, 2024

Related U.S. Application Data
(63) Continuation of application No. PCT/JP2022/042641, filed on Nov. 17, 2022.

(30) Foreign Application Priority Data
Nov. 25, 2021 (JP) 2021-191526

(51) Int. Cl. G02B 13/14; B60Q 9/00; B60T 8/172; G01S 7/481; G01S 17/931; G02B 9/16; G02B 13/18; G06V 10/147; G06V 20/58; H04N 23/55

(52) U.S. Cl. CPC G02B 13/14; B60Q 9/008; B60T 8/172; G01S 7/4816; G01S 17/931; G02B 9/16; G02B 13/18; G06V 10/147; G06V 20/58; H04N 23/55; B60T 2201/022; B60T 2210/32

(57) ABSTRACT

An optical system includes a first lens L1 with positive refractive power, a second lens L2 with negative refractive power, and a third lens L3 with positive refractive power, placed in this order from an object side to an image side. At least one of the first lens L1 and the third lens L3 is made of chalcogenide material, and the second lens L2 is made of glass material. The following inequality is satisfied: 0.75<Np−Nn, where Np is a refractive index of the lens made of the chalcogenide material at a wavelength of 0.9 μm, and Nn is a refractive index of the second lens at a wavelength of 0.9 μm.

### CROSS-REFERENCE TO RELATED APPLICATIONS

This application is a Continuation of International Patent Application No. PCT/JP2022/042641, filed Nov. 17, 2022, which claims the benefit of Japanese Patent Application No. 2021-191526, filed Nov. 25, 2021, both of which are hereby incorporated by reference herein in their entirety.

### BACKGROUND OF THE INVENTION

### Field of the Invention

The present invention relates to an optical system for infrared light that is suitable for use in distance measurement devices, such as on-board systems and monitoring systems.

### Background Art

Distance measurement devices are known that illuminate a target object (object) using an illumination device and calculate a distance to the target object based on the time taken to receive reflected light from the target object and the phase of the reflected light. Such distance measurement devices need to use infrared light (infrared rays) because distance measurement performance of infrared light is less likely to be affected by obstacles, such as fog, and infrared light has less impact on human eyes.

PTL 1 discusses a distance measurement device including an optical system using a chalcogenide lens having high transmittance with respect to infrared light.

### CITATION LIST

### Patent Literature

PTL 1: Japanese Patent Application Laid-Open No. 2012-037697

In general, infrared sensors for infrared light are less sensitive than visible light sensors, so that a distance measurement device using infrared light needs to use an optical system with a sufficiently small f-number (high brightness). However, PTL 1 does not consider an f-number of the optical system and is silent on configurations of the optical system for effectively correcting various aberrations, such as spherical aberration and field curvature, while reducing the f-number sufficiently.

The present invention is directed to an optical system that has a sufficiently small f-number and is capable of correcting various aberrations effectively, a distance measurement device including the same, and an on-board system.

### SUMMARY OF THE INVENTION

According to an aspect of the present invention, an optical system includes a first lens with positive refractive power, a second lens with negative refractive power, and a third lens with positive refractive power, placed in this order from an object side to an image side, wherein at least one of the first lens and the third lens is made of chalcogenide material, and the second lens is made of glass material, and wherein the following inequality is satisfied: 0.75<Np−Nn, where Np is a refractive index of the lens made of the chalcogenide material at a wavelength of 0.9 μm, and Nn is a refractive index of the second lens at a wavelength of 0.9 μm.

Further features of the present invention will become apparent from the following description of exemplary embodiments with reference to the attached drawings.

### BRIEF DESCRIPTION OF THE DRAWINGS

FIG. 1 is an overview diagram illustrating key elements of an optical system according to a first exemplary embodiment.

FIG. 2 is a modulation transfer function (MTF) chart of the optical system according to the first exemplary embodiment.

FIG. 3 is an overview diagram illustrating key elements of an optical system according to a second exemplary embodiment.

FIG. 4 is an MTF chart of the optical system according to the second exemplary embodiment.

FIG. 5 is an overview diagram illustrating key elements of an optical system according to a third exemplary embodiment.

FIG. 6 is an MTF chart of the optical system according to the third exemplary embodiment.

FIG. 7 is an overview diagram illustrating key elements of an optical system according to a fourth exemplary embodiment.

FIG. 8 is an MTF chart of the optical system according to the fourth exemplary embodiment.

FIG. 9 is a schematic diagram illustrating an image capturing apparatus according to an exemplary embodiment.

FIG. 10 is a schematic diagram illustrating a distance measurement device according to an exemplary embodiment.

FIG. 11 is a functional block diagram illustrating an on-board system according to an exemplary embodiment.

FIG. 12 is a schematic diagram illustrating a moving device according to an exemplary embodiment.

FIG. 13 is a flowchart illustrating an example of operations of an on-board system according to an exemplary embodiment.

### DESCRIPTION OF THE EMBODIMENTS

Preferred exemplary embodiments of the present invention will be described below with reference to the drawings. For convenience, illustrations in the drawings may be at a different scale from the actual size. Corresponding members are also assigned the same reference number in the drawings, and redundant descriptions thereof are omitted.

### First Exemplary Embodiment

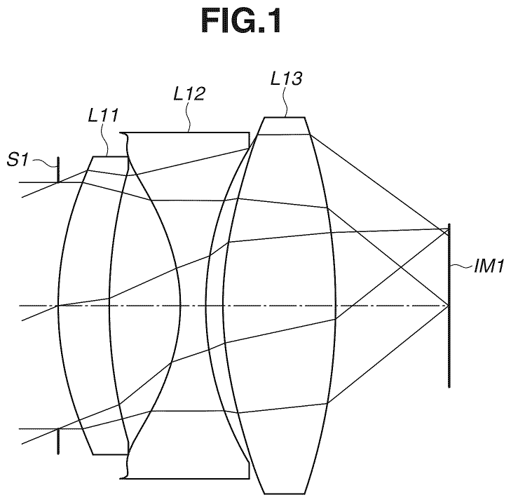

FIG. 1 is an overview diagram illustrating key elements along a cross section including an optical axis of an optical system according to a first exemplary embodiment of the present invention. In FIG. 1, the left side is an object side (front), and the right side is an image side (rear). In FIG. 1, only marginal rays of on-axis light fluxes that are converged at an on-axis image height and marginal rays of most off-axis light fluxes that are converged at one of extreme off-axis image heights are illustrated, and other light rays are omitted.

The optical system according to the present exemplary embodiment is an image forming optical system configured to form an image of an object (not illustrated) on an image plane IM1 by converging light from the object. Specifically, the optical system according to the present exemplary embodiment has positive refractive power throughout the whole optical system. In a case where the optical system according to the present exemplary embodiment is applied to an image capturing apparatus or a distance measurement device, a light receiving surface (image capturing surface) of a photodetector (image sensor) is positioned at the location of the image plane IM1.

The optical system according to the present exemplary embodiment consists of a first lens L11 with positive refractive power, a second lens L12 with negative refractive power, and a third lens L13 with positive refractive power, placed in this order from the object side to the image side. On the object side of the first lens L11, a stop S1 (aperture stop) is placed. The stop S1 determines an f-number (Fno) of the optical system by limiting light from the object. According to the present exemplary embodiment, the first lens L11 and the third lens L13 are made of chalcogenide material, and the second lens L12 is made of S-FPL53 (OHARA Inc.).

The term “chalcogenide material” herein refers to a material containing a chalcogenide as its main component. Chalcogenides are compounds containing chalcogen elements, such as sulfur (S), selenium (Se), or tellurium (Te). Some chalcogenides contain germanium (Ge), antimony (Sb), phosphorus (P), or arsenic (AS) in addition to chalcogen elements. Chalcogenide materials herein refer to not only materials that contain only chalcogenides but also materials that contain trace amounts of substances (impurities) other than chalcogenides.

While a refractive index of chalcogenide material may vary depending on the ratio of chalcogen elements and other elements contained in the chalcogenide, the manufacturing method, or the manufacturer, at least the use of chalcogenide material produces a similar advantageous effect to that produced by the present exemplary embodiment. Further, material of the second lens L12 is not limited to S-FPL53, and with any material that satisfies inequality (1) described below, a similar advantageous effect to that produced by the present exemplary embodiment is produced.

As described above, in the optical system, at least one positive lens is made of chalcogenide material, and at least one negative lens is made of material having a lower refractive index than the refractive index of the chalcogenide material, whereby it becomes possible to correct various aberrations effectively while reducing the f-number sufficiently. This will be described in detail below.

In a case where the f-number of the optical system is reduced, incidence angles of extreme off-axis light rays with respect to the lens closest to the object side increase, so that the extreme off-axis light rays need to be refracted greatly by the lenses in order to converge the extreme off-axis light rays to a light receiving surface positioned in the image plane. In this case, as the refractive power of each lens increases, spherical aberration occurs significantly. Further, reducing the f-number of the optical system can lead to an increased occurrence of field curvature, especially in a case where an angle of view of the optical system is increased.

Since field curvature in the optical system is correlated with the Petzval sum, the Petzval sum needs to be reduced sufficiently in order to correct field curvature effectively. A Petzval sum is expressed by formula (A) below:

$$Psum = 1 / f 1 n 1 + 1 / f 2 n 2 + 1 / f 3 n 3 , \qquad ( A )$$

where f1 is a focal length of the first lens L11, n1 is a refractive index of the first lens L11,
f2 is a focal length of the second lens L12, n2 is a refractive index of the second lens L12,
f3 is a focal length of the third lens L13, and n3 is a refractive index of the third lens L13.
The refractive indexes n1, n2, and n3 are refractive indexes for the same wavelength.

Since the refractive indexes of the materials used in the lenses are positive, at least one lens is to have a negative focal length in order to reduce the Petzval sum, as indicated by formula (A). Specifically, the optical system is desirably configured with a combination of a positive lens with a positive focal length (positive refractive power) and a negative lens with a negative focal length (negative refractive power). In the optical system according to the present exemplary embodiment, the first lens L11 and the third lens L13 are positive lenses, and the second lens L12 is a negative lens, whereby the Petzval sum is reduced sufficiently.

In order to form an image of an object on the light receiving surface, the refractive power of the entire system of the optical system needs to be a positive value. In this configuration, it is desirable to reduce the number of negative lenses in order to reduce the Petzval sum with as few lenses as possible. It is also desirable to use a plurality of positive lenses in order to correct both spherical aberration and field curvature effectively. Thus, the optical system according to the present exemplary embodiment is configured with two positive lenses and one negative lens. While the optical system may be configured with four or more lenses as needed, it is more desirable to configure the optical system with three lenses in order to reduce the size of the entire system as in the present exemplary embodiment.

In a case where the optical system is configured with a small number of lenses, the absolute value of the focal length of the negative lens needs to be reduced sufficiently to be close to the combined focal length of the positive lenses in order to reduce the Petzval sum sufficiently, as indicated by formula (A). However, the absolute value of the refractive power of each lens needs to be reduced in order to prevent spherical aberration especially in a case where the f-number is reduced, as described above. Specifically, the difference in refractive index between the positive and negative lenses is desirably as great as possible in order to correct field curvature effectively while preventing spherical aberration.

The refractive index of a commonly-used glass material intended for use primarily in the visible wavelength range, such as S-FPL53 described above, ranges from around 1.43 at a minimum to around 1.97 at a maximum, at a wavelength of 0.9 μm. Thus, in a case where each lens of the optical system is made only of commonly-used glass material, the maximum possible difference in refractive index between the positive and negative lenses is around 0.54, so that it is difficult to correct field curvature effectively while reducing the f-number sufficiently.

Thus, the negative lens is made of commonly-used glass material, and at least one positive lens is made of chalcogenide material with a refractive index significantly higher than the refractive index of the commonly-used glass material, according to the present exemplary embodiment. Chalcogenide materials transmit infrared light in the wavelength range from around 0.7 μm to around 14.0 μm. Furthermore, the refractive indexes of chalcogenide materials at a wavelength of 0.9 μm are sufficiently higher than that of the commonly-used glass material. Specifically, the refractive index of the chalcogenide material that is used in the present exemplary embodiment is around 2.75. The refractive index of the commonly-used glass material is around 1.43 to around 1.97 at a wavelength of 0.9 μm as described above, and thus the difference in refractive index between the positive and negative lenses of the optical system according to the present exemplary embodiment is around 0.78 to around 1.32 at a maximum, which is sufficient.

In other words, the optical system according to the present exemplary embodiment satisfies the following inequality (1):

$$0.75 < Np - Nn , \qquad ( 1 )$$

where Np is the refractive index of the positive lens made of chalcogenide material at a wavelength of 0.9 μm, and Nn is the refractive index of the negative lens at a wavelength of 0.9 μm.

Here, the optical system is intended for application to a distance measurement device that uses infrared light, and thus 0.9 μm is selected as a reference wavelength for the refractive index. With the positive lens made of chalcogenide material and the negative lens made of material that satisfies inequality (1), there is a sufficient difference in refractive index between the positive and negative lenses. This makes it possible to reduce the Petzval sum sufficiently while preventing an increase in refractive power of the lenses, so that it is still possible to correct spherical aberration and field curvature effectively even in a case where the f-number of the optical system is reduced. In a case where the value of Np-Nn falls below the lower limit of inequality (1), the difference in refractive index between the positive and negative lenses becomes insufficient, so that it becomes difficult to correct spherical aberration and field curvature effectively in a case where the f-number is reduced.

In a case where the value of Np-Nn becomes excessively large, the freedom of material selection for the lenses decreases, so that it becomes difficult to configure the optical system that has desired material performance. In order to increase the freedom of material selection, the range of inequality (1) is therefore desirably set as expressed by the following inequality (1a):

$$0.75 < Np - Nn < 1.45 . \qquad ( 1 a )$$

Furthermore, the following inequality (1b) is desirably satisfied:

$$0.8 < Np - Nn < 1.4 . \qquad ( 1 b )$$

More desirably, the following inequality (1c) is satisfied:

$$0.9 < Np - Nn < 1.35 . \qquad ( 1 c )$$

While the first lens L11 and the third lens L13 are both made of chalcogenide material according to the present exemplary embodiment, an advantageous effect of the present invention is still produced if at least one of the first lens L11 and the third lens L13 is made of chalcogenide material. Specifically, spherical aberration and field curvature are corrected effectively by converging light rays having entered the optical system at a large incidence angle to the chalcogenide material having a high refractive index. However, in a case where the optical system has an especially small f-number, off-axis light rays enter at a large incidence angle, and this can lead to an increased occurrence of various aberrations. At least the first lens L11 closest to the object side is thus desirably made of chalcogenide material in order to correct various aberrations effectively. More desirably, the first lens L11 and the third lens L13 are both made of chalcogenide material.

As described above, in a case where the optical system has a small f-number, it is necessary to correct field curvature effectively while preventing spherical aberration. At this time, spherical aberration is likely to occur in lenses where off-axis light rays enter at a relatively high position with respect to the optical axis, and thus the value of the focal length ratio between the first lens L11 closest to the object side and the second lens L12 placed on the image side of the first lens L11 is desirably set properly. Specifically, the following inequality (2) is desirably satisfied:

$$- 3. < f 1 / f 2 < - 1. . \qquad ( 2 )$$

By satisfying inequality (2), the focal lengths of the first lens L11 and the second lens L12 are set properly, thereby making it possible to correct spherical aberration and field curvature with a suitable balance in the optical system of a small f-number. In a case where inequality (2) is not satisfied, the value of the focal length of the first lens L11 becomes excessively large or small relative to the absolute value of the focal length of the second lens L12, and this can lead to insufficient correction of either spherical aberration or field curvature. Furthermore, the following inequality (2a) is desirably satisfied:

$$- 2.9 < f 1 / f 2 < - 1.2 . \qquad ( 2 a )$$

More desirably, the following inequality (2b) is satisfied:

$$- 2.8 < f 1 / f 2 < - 1.5 . \qquad ( 2 b )$$

Further, the following inequality (3) is desirably satisfied:

$$- 3. < f 2 / fr < - 0.5 , \qquad ( 3 )$$

where fr is a combined focal length of lenses positioned closer to the image than the second lens L12 is. According to the present exemplary embodiment, the third lens L13 is the only lens positioned closer to the image than the second lens L12 is, so that fr=f3.

By satisfying inequality (3), the focal lengths of the second lens L12 and lenses placed on the image side of the second lens L12 are set properly, and this makes it possible to correct field curvature more effectively. In a case where inequality (3) is not satisfied, the absolute value of the focal length of the second lens L12 becomes excessively large or small relative to the combined focal length fr, and it becomes difficult to correct field curvature more effectively. Furthermore, the following inequality (3a) is desirably satisfied:

$$- 2.7 < f 2 / fr < - 1. . \qquad ( 3 a )$$

More desirably, the following inequality (3b) is satisfied:

$$- 2.5 < f 2 / fr < - 1.2 . \qquad ( 3 b )$$

Further, the following inequality (4) is desirably satisfied:

$$0.1 < fr / f 1 < 1. . \qquad ( 4 )$$

By satisfying inequality (4), the focal lengths of the first lens L11 and lenses placed on the image side of the second lens L12 are set properly, and this makes it possible to correct field curvature and spherical aberration more effectively. In a case where the value of fr/f1 exceeds the upper limit of inequality (4), the combined focal length fr becomes greater than the focal length of the first lens L11, and this can lead to insufficient correction of spherical aberration or field curvature. In a case where the value of fr/f1 falls below the lower limit of inequality (4), the focal length of the first lens L11 becomes excessively greater than the combined focal length fr, and this can lead to insufficient correction of spherical aberration or field curvature. Furthermore, the following inequality (4a) is desirably satisfied:

$$0.15 < fr / f 1 < 0.8 . \qquad ( 4 a )$$

More desirably, the following inequality (4b) is satisfied:

$$0.2 < fr / f 1 < 0.5 . \qquad ( 4 b )$$

Further, the following inequality (5) is desirably satisfied:

$$0.1 < f 1 / f < 3. , \qquad ( 5 )$$

where f is the (total) focal length of the optical system according to the present exemplary embodiment.

By satisfying inequality (5), it becomes possible to correct spherical aberration more effectively. In a case where the value of f1/f exceeds the upper limit of inequality (5), the refractive power of the first lens L11 becomes excessively small, and it becomes difficult to correct spherical aberration effectively. In a case where the value of f1/f falls below the lower limit of inequality (5), the refractive power of the first lens L11 becomes excessively large, and this can lead to an increased occurrence of various aberrations. Furthermore, the following inequality (5a) is desirably satisfied:

$$1. < f 1 / f < 2.7 . \qquad ( 5 a )$$

More desirably, the following inequality (5b) is satisfied:

$$1.5 < f 1 / f < 2.5 . \qquad ( 5 b )$$

Further, the following inequality (6) is desirably satisfied:

$$- 3. < f 2 / f < - 0.1 . \qquad ( 6 )$$

By satisfying inequality (6), it becomes possible to correct spherical aberration and field curvature more effectively in a case where the f-number of the optical system is reduced. In a case where inequality (6) is not satisfied, the absolute value of the refractive power of the second lens L12 becomes excessively large or small, and it becomes difficult to correct spherical aberration and field curvature with a suitable balance. Furthermore, the following inequality (6a) is desirably satisfied:

$$- 2.5 < f 2 / f < - 0.3 . \qquad ( 6 a )$$

More desirably, the following inequality (6b) is satisfied:

$$- 2. < f 2 / f < - 0.5 . \qquad ( 6 b )$$

Further, the following inequality (7) is desirably satisfied:

$$0.1 < fr / f < 2. . \qquad ( 7 )$$

By satisfying inequality (7), it becomes possible to correct field curvature more effectively. In a case where the value of fr/f exceeds the upper limit of inequality (7), the refractive power of the combined system closer to the image than the second lens L12 is becomes excessively small, and it becomes difficult to correct field curvature effectively. In a case where the value of fr/f falls below the lower limit of inequality (7), the refractive power of the combined system closer to the image than the second lens L12 is becomes excessively large, and this can lead to an increased occurrence of various aberrations. Furthermore, the following inequality (7a) is desirably satisfied:

$$0.2 < fr / f < 1.5 . \qquad ( 7 a )$$

More desirably, the following inequality (7b) is satisfied:

$$0.3 < fr / f < 1. . \qquad ( 7 b )$$

Further, the following inequality (8) is desirably satisfied:

$$0.6 < Fno < 1. , \qquad ( 8 )$$

where Fno is the f-number of the optical system according to the present exemplary embodiment.

In a case where an optical system is made only of commonly-used glass material, it is difficult to reduce the f-number to be smaller than 1.0. On the contrary, some of the lenses of the optical system according to the present exemplary embodiment are made of chalcogenide material to make it possible to reduce the f-number to be smaller than 1.0. Specifically, the f-number of the optical system according to the present exemplary embodiment is 0.80. In a case where the value of Fno falls below the lower limit of inequality (8), it becomes difficult to correct various aberrations effectively.

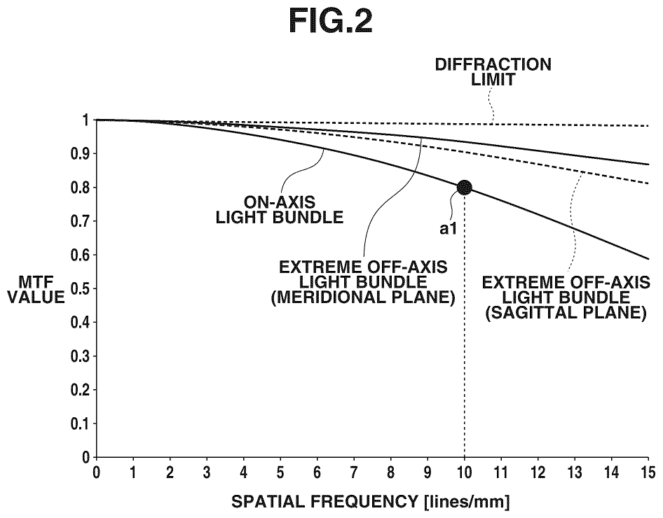

FIG. 2 is a diagram illustrating modulation transfer function (MTF) curves of the optical system according to the present exemplary embodiment. In FIG. 2, the horizontal axis represents spatial frequencies [lines/mm], and the vertical axis represents MTF values (contrast values). The present exemplary embodiment is intended for cases where the optical system forms an object image with light with a wavelength of 0.9 μm. A typical pixel pitch of an infrared sensor is several tens of micrometers, and thus effective image forming performance is considered to be achieved in a case where the MTF value is 30% or higher at a spatial frequency of 10 lines/mm. As illustrated in FIG. 2, a minimum value a1 of the MTF value of the optical system according to the present exemplary embodiment is around 80% at a spatial frequency of 10 lines/mm, so that effective image forming performance is achieved.

### Second Exemplary Embodiment

An optical system according to a second exemplary embodiment of the present invention will be described below. Descriptions are omitted of each component of the optical system according to the present exemplary embodiment that is equivalent to a component of the optical system according to the first exemplary embodiment.

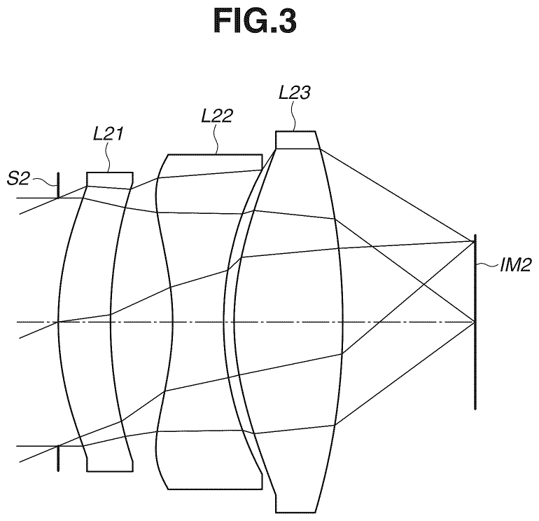

FIG. 3 is an overview diagram illustrating key elements in a cross section including an optical axis of the optical system according to the present exemplary embodiment. The optical system according to the present exemplary embodiment is an image forming optical system configured to converge light having passed through a stop S2 to an image plane IM2. The optical system according to the present exemplary embodiment differs from the optical system according to the first exemplary embodiment in each lens surface shape and placement.

Similarly to the optical system according to the first exemplary embodiment, the optical system according to the present exemplary embodiment consists of a first lens L21 with positive refractive power, a second lens L22 with negative refractive power, and a third lens L23 with positive refractive power, placed in this order from the object side to the image side. The first lens L21 and the third lens L23 are made of chalcogenide material, and the second lens L22 is made of S-NBH56 (OHARA Inc.).

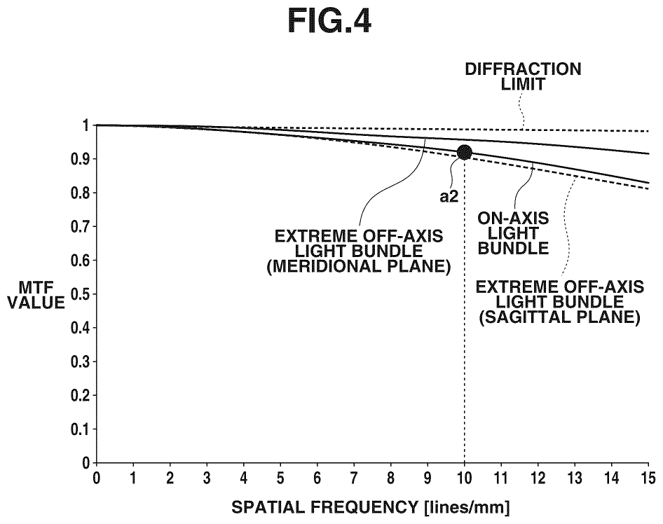

FIG. 4 is a diagram illustrating MTF curves of the optical system according to the present exemplary embodiment. The present exemplary embodiment is intended for cases where the optical system forms an object image by using light with a wavelength of 0.9 μm. As illustrated in FIG. 4, a minimum value a2 of the MTF value of the optical system according to the present exemplary embodiment is around 90% at a spatial frequency of 10 lines/mm, so that effective image forming performance is achieved.

### Third Exemplary Embodiment

An optical system according to a third exemplary embodiment of the present invention will be described below. Descriptions are omitted of each component of the optical system according to the present exemplary embodiment that is equivalent to a component of the optical system according to the first exemplary embodiment.

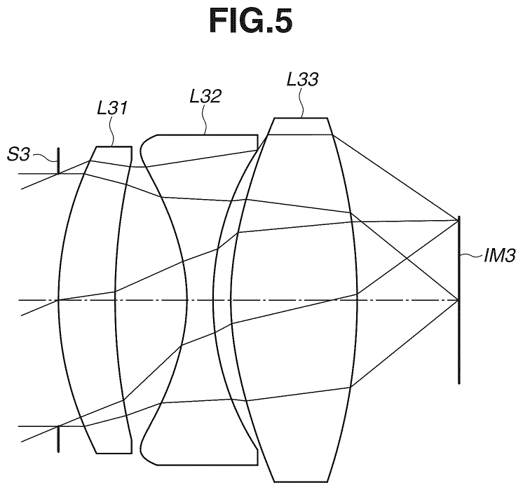

FIG. 5 is an overview diagram illustrating key elements in a cross section including an optical axis of the optical system according to the present exemplary embodiment. The optical system according to the present exemplary embodiment is an image forming optical system configured to converge light having passed through a stop S3 to an image plane IM3. The optical system according to the present exemplary embodiment differs from the optical system according to the first exemplary embodiment in each lens surface shape and placement.

Similarly to the optical system according to the first exemplary embodiment, the optical system according to the present exemplary embodiment consists of a first lens L31 with positive refractive power, a second lens L32 with negative refractive power, and a third lens L33 with positive refractive power, placed in this order from the object side to the image side. The first lens L31 and the third lens L33 are made of chalcogenide material, and the second lens L32 is made of S-BSL7 (OHARA Inc.).

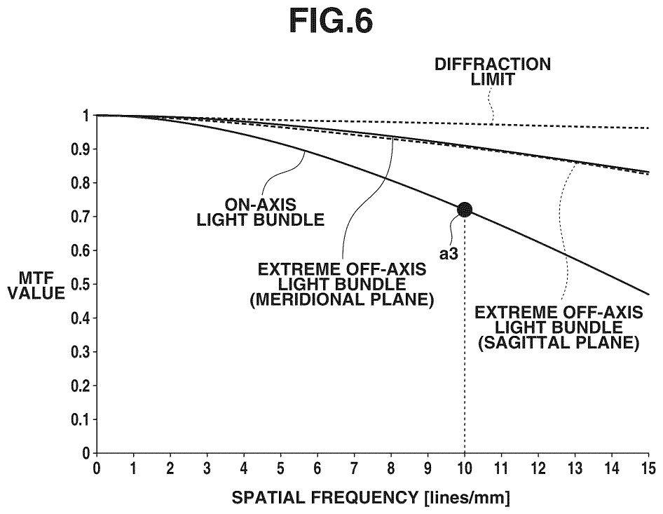

FIG. 6 is a diagram illustrating MTF curves of the optical system according to the present exemplary embodiment. The present exemplary embodiment is intended for cases where the optical system forms an object image by using light with a wavelength of 2.0 μm. As illustrated in FIG. 6, a minimum value a3 of the MTF value of the optical system according to the present exemplary embodiment is around 72% at a spatial frequency of 10 lines/mm, so that effective image forming performance is achieved. As described above, even in a case where light with a long wavelength such as 2.0 μm is used, an advantageous effect of the present invention is still produced by satisfying inequality (1) as long as the wavelength is within transmittance wavelength ranges of the lenses.

### Fourth Exemplary Embodiment

An optical system according to a fourth exemplary embodiment of the present invention will be described below. Descriptions are omitted of each component of the optical system according to the present exemplary embodiment that is equivalent to a component of the optical system according to the first exemplary embodiment.

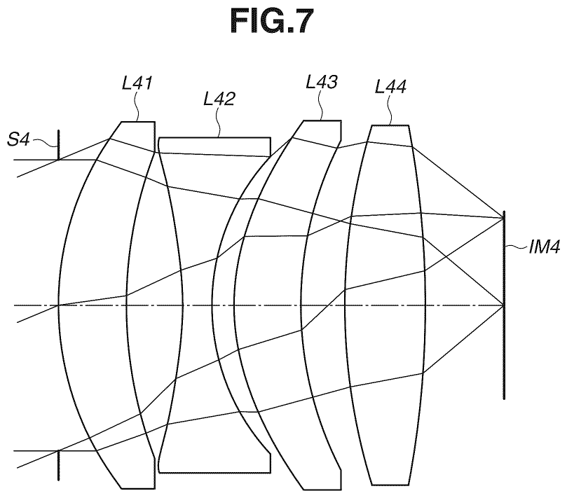

FIG. 7 is an overview diagram illustrating key elements in a cross section including an optical axis of the optical system according to the present exemplary embodiment. The optical system according to the present exemplary embodiment is an image forming optical system configured to converge light having passed through a stop S4 to an image plane IM4. Unlike the optical system according to the first exemplary embodiment, the optical system according to the present exemplary embodiment consists of four lenses.

Specifically, the optical system according to the present exemplary embodiment consists of a first lens L41 with positive refractive power, a second lens L42 with negative refractive power, a third lens L43 with positive refractive power, and a fourth lens L44 with positive refractive power, placed in this order from the object side to the image side. According to the present exemplary embodiment, the first lens L41, the third lens L43, and the fourth lens L44 are made of chalcogenide material, and the second lens L42 is made of S-BSL7 (OHARA Inc.).

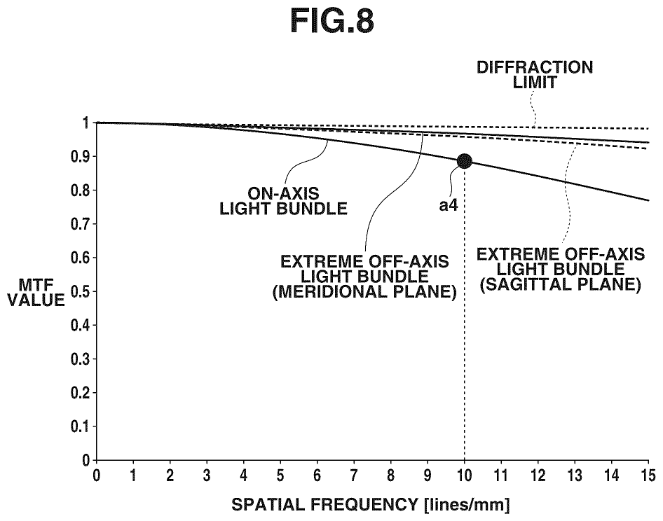

FIG. 8 is a diagram illustrating MTF curves of the optical system according to the present exemplary embodiment. The present exemplary embodiment is intended for cases where the optical system forms an object image by using light with a wavelength of 0.9 μm. As illustrated in FIG. 8, a minimum value a4 of the MTF value of the optical system according to the present exemplary embodiment is around 88% at a spatial frequency of 10 lines/mm, so that effective image forming performance is achieved. As described above, even in a case where the optical system consists of four or more lenses, an advantageous effect of the present invention is still produced by satisfying inequality (1).

### Numerical Examples

First to fourth numerical examples corresponding to the first to fourth exemplary embodiments described above will be described below. In the numerical examples, surface numbers indicate the order of each optical surface counted from an object surface. Further, r [mm] represents a radius of curvature of the i-th optical surface, and d [mm] represents a distance between the i-th optical surface and the (i+1)th optical surface. An asterisk (*) is placed next to the surface number of each aspherical surface.

A sag amount Z [mm] indicating the shape of an aspherical surface in the direction of an optical axis is expressed by formula 1 below, where k is a conic constant, h is a distance [mm] from the optical axis in a radial direction, and A to E are aspheric coefficients of the 4th to 12th order terms. While only the aspheric coefficients of the 4th to 12th order terms are used herein, an aspheric coefficient of the 16th or higher order term may be used as needed. The radius of curvature r of an aspherical surface indicates the value of a paraxial radius of curvature and corresponds to the radius of curvature of a base spherical surface (reference spherical surface) used as a reference for the sag amount Z. Further, “E±X” in the values of the aspheric coefficients in the numerical examples refer to “10^{±X}”.

$$Z = \frac{( 1 / r ) {h}^{2}}{1 + \sqrt{1 - ( 1 + k ) ( 1 / r )}} + {Ah}^{4} + {Bh}^{6} + {Ch}^{8} + {Dh}^{10} + {Eh}^{12} \qquad [ Formula 1 ]$$

### First Numerical Example

| | Surface Number | r | d | Material |
|---|---|---|---|---|
| Object Surface | 0 | ∞ | ∞ | |
| Stop | 1 | ∞ | 0.00 | |
| First Lens | 2* | 15.97 | 2.61 | Chalcogenide |
| | | | | Material |
| | 3 | 24.90 | 3.64 | |
| Second Lens | 4* | −8.81 | 1.30 | S-FPL53 |
| | 5 | 15.45 | 0.88 | |
| Third Lens | 6* | 17.14 | 5.76 | Chalcogenide |
| | | | | Material |
| | 7 | −29.47 | 5.81 | |
| Image Plane | 8 | ∞ | | |

| | Surface Number 2 | Surface Number 4 | Surface Number 6 |
|---|---|---|---|
| r | 15.97 | −8.81 | 17.14 |
| k | 0.00 | 0.00 | 0.00 |
| A | −1.60E−05 | 5.46E−04 | −1.69E−04 |
| B | 3.50E−07 | −1.20E−05 | 1.62E−06 |
| C | −2.01E−08 | 2.67E−07 | −1.96E−08 |
| D | 4.40E−10 | −2.57E−09 | 1.40E−10 |
| E | −5.24E−12 | 2.31E−11 | −2.19E−13 |

### Second Numerical Example

| | Surface Number | r | d | Material |
|---|---|---|---|---|
| Object Surface | 0 | ∞ | ∞ | |
| Stop | 1 | ∞ | 0.00 | |
| First Lens | 2* | 14.20 | 2.50 | Chalcogenide |
| | | | | Material |
| | 3 | 21.09 | 2.99 | |
| Second Lens | 4* | −11.94 | 2.44 | S-NBH56 |
| | 5 | 15.02 | 0.50 | |
| Third Lens | 6* | 12.55 | 5.21 | Chalcogenide |
| | | | | Material |
| | 7 | −31.61 | 6.36 | |
| Image Plane | 8 | ∞ | | |

| | Surface Number 2 | Surface Number 4 | Surface Number 6 |
|---|---|---|---|
| r | 14.20 | −11.94 | 12.55 |
| k | 0.00 | 0.00 | 0.00 |
| A | −3.74E−05 | 8.35E−04 | −3.62E−04 |
| B | −1.80E−07 | −1.84E−05 | 5.07E−06 |
| C | −2.83E−08 | 4.48E−07 | −8.34E−08 |
| D | 5.33E−10 | −2.45E−09 | 7.39E−10 |
| E | −1.45E−11 | −8.65E−12 | −2.87E−12 |

### Third Numerical Example

| | Surface Number | r | d | Material |
|---|---|---|---|---|
| Object Surface | 0 | ∞ | ∞ | |
| Stop | 1 | ∞ | 0.00 | |
| First Lens | 2* | 15.66 | 2.82 | Chalcogenide |
| | | | | Material |
| | 3 | 29.39 | 3.59 | |
| Second Lens | 4* | −8.64 | 1.30 | S-BSL7 |
| | 5 | 13.48 | 0.89 | |
| Third Lens | 6* | 14.30 | 6.31 | Chalcogenide |
| | | | | Material |
| | 7 | −27.89 | 5.09 | |
| Image Plane | 8 | ∞ | | |

| | Surface Number 2 | Surface Number 4 | Surface Number 6 |
|---|---|---|---|
| r | 15.66 | −8.64 | 14.30 |
| k | 0.00 | 0.00 | 0.00 |
| A | −1.03E−05 | 1.04E−03 | −2.91E−04 |
| B | 4.53E−07 | −4.25E−05 | 5.17E−06 |
| C | −2.68E−08 | 1.52E−06 | −1.08E−07 |
| D | 6.42E−10 | −2.84E−08 | 1.30E−09 |
| E | −6.28E−12 | 2.24E−10 | −6.14E−12 |

### Fourth Numerical Example

| | Surface Number | r | d | Material |
|---|---|---|---|---|
| Object Surface | 0 | ∞ | ∞ | |
| Stop | 1 | ∞ | 0.00 | |
| First Lens | 2* | 13.01 | 3.02 | Chalcogenide |
| | | | | Material |
| | 3 | 18.73 | 2.50 | |
| Second Lens | 4* | −13.48 | 1.30 | S-BSL7 |
| | 5 | 9.56 | 0.98 | |
| Third Lens | 6* | 9.65 | 2.97 | Chalcogenide |
| | | | | Material |
| | 7 | 15.69 | 1.96 | |
| Fourth Lens | 8 | 26.55 | 3.58 | Chalcogenide |
| | | | | Material |
| | 9 | −42.30 | 3.50 | |
| Image Plane | 10 | ∞ | | |

| | Surface Number 2 | Surface Number 4 | Surface Number 6 |
|---|---|---|---|
| r | 13.01 | −13.48 | 9.65 |
| k | 0.00 | 0.00 | 0.00 |
| A | −1.08E−05 | 1.23E−03 | −3.76E−04 |
| B | 5.01E−07 | −5.12E−05 | 5.70E−06 |
| C | −2.34E−08 | 1.46E−06 | −1.30E−07 |
| D | 6.66E−10 | −2.55E−08 | 1.47E−09 |
| E | −6.13E−12 | 1.97E−10 | −8.93E−12 |

Table 1 below presents values related to the inequalities for the optical systems according to the exemplary embodiments described above. In Table 1, f4 is a focal length of the fourth lens LA4, and the focal lengths are in units of [mm]. Further, the combined focal length fr according to the fourth exemplary embodiment is a combined focal length of the third lens LA3 and the fourth lens LA4. As presented in Table 1, all the optical systems according to the exemplary embodiments satisfy the inequalities.

TABLE 1

| | First | Second | Third | Fourth |
|---|---|---|---|---|
| | Exemplary | Exemplary | Exemplary | Exemplary |
| | Embodiment | Embodiment | Embodiment | Embodiment |
| (1) Np − Nn | 1.32 | 0.92 | 1.24 | 1.24 |
| (2) f1/f2 | −1.68 | −2.60 | −1.73 | −1.68 |
| (3) f2/fr | −1.90 | −1.40 | −1.65 | −1.64 |
| (4) fr/f1 | 0.31 | 0.28 | 0.35 | 0.36 |
| (5) f1/f | 2.14 | 2.01 | 1.81 | 1.82 |
| (6) f2/f | −1.27 | −0.77 | −1.04 | −1.08 |
| (7) fr/f | 0.67 | 0.55 | 0.63 | 0.66 |
| (8) Fno | 0.80 | 0.85 | 0.80 | 0.78 |
| Np | 2.75 | 2.75 | 2.75 | 2.75 |
| Nn | 1.43 | 1.83 | 1.51 | 1.51 |
| f1 | 21.39 | 20.10 | 18.11 | 18.16 |
| f2 | −12.71 | −7.73 | −10.45 | −10.80 |
| f3 | 6.70 | 5.53 | 6.35 | 10.87 |
| f4 | — | — | — | 9.61 |
| fr | 6.70 | 5.53 | 6.35 | 6.58 |
| f | 10 | 10 | 10 | 10 |

### [Image Capturing Apparatus]

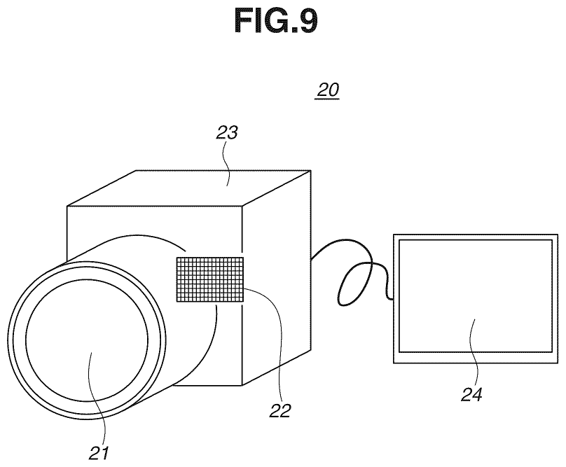

FIG. 9 is an overview diagram illustrating an image capturing apparatus 20 according to an exemplary embodiment of the present invention. The image capturing apparatus 20 according to the present exemplary embodiment includes an optical system (image capturing optical system) 21 according to any one of the exemplary embodiments described above, a photodetector 22, and a camera body (housing) 23. The photodetector 22 photoelectrically converts object images formed by the optical system 21, and the camera body 23 holds the photodetector 22. The optical system 21 is held by a lens barrel (holding member) and is connected to the camera body 23. A display unit 24 for displaying images acquired by the photodetector 22 may be connected to the camera body 23.

An image sensor (photoelectric conversion element), such as a charge coupled device (CCD) sensor or a complementary metal-oxide-semiconductor (CMOS) sensor, may be used as the photodetector 22. In a case where the image capturing apparatus 20 is applied to a distance measurement device, an infrared sensor capable of photoelectrically converting infrared light is desirably used as the photodetector 22. The optical system 21 and the camera body 23 may be configured to be attachable to and detachable from each other. In other words, the optical system 21 and the lens barrel may be configured as an interchangeable lens (lens device).

The image capturing apparatus 20 according to the present exemplary embodiment may be installed in a movable object (moving device). Further, the optical systems according to the exemplary embodiments described above are applicable to not only image capturing apparatuses, such as digital still cameras, silver halide film cameras, video cameras, on-board cameras, and monitoring cameras, but also various optical apparatuses, such as telescopes, binoculars, projectors, and digital copy machines.

### [Distance Measurement Device]

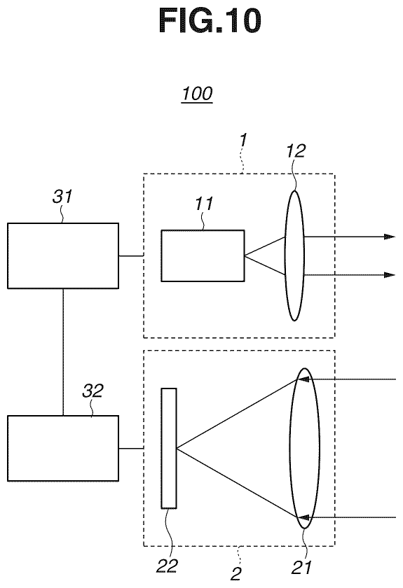

FIG. 10 is an overview diagram (schematic diagram) illustrating a distance measurement device 100 according to an exemplary embodiment of the present invention along a cross section including the optical axis. The distance measurement device 100 according to the present exemplary embodiment uses Light Detection and Ranging (LiDAR) technique for calculating a distance to a target object (object) based on the time taken to receive reflected light from the target object and the phase of the reflected light. In FIG. 10, a target object (not illustrated) is placed on the right side of the distance measurement device 100.

The distance measurement device 100 includes an illumination unit 1 and a light receiving unit (image capturing unit) 2. The light receiving unit 2 receives light (reflected light or scattered light) from a target object illuminated by the illumination unit 1. The illumination unit 1 includes a light source unit 11 and an optical system (illumination optical system) 12. The optical system 12 guides (applies) light from the light source unit 11 to a target object. The light receiving unit 2 includes the optical system (light receiving optical system) 21 according to any one of the exemplary embodiments described above and the photodetector 22 configured to receive light from the optical system 21 and output signals. In other words, the image capturing apparatus 20 described above may be used as the light receiving unit 2.

The light source unit 11 includes at least a light source and may also include an optical element for guiding light from the light source to the optical system 12 and a scan unit for scanning a target object through the optical system 12 by polarizing light from the light source, as needed. As the scan unit, a movable mirror may be used, such as a galvano mirror or a microelectromechanical systems (MEMS) mirror or an optical element, such as a crystalline element or a liquid crystal element with a refractive index changeable by applying a voltage. With the latter optical element, no mechanism (drive unit) for mirror driving is necessary, so that the total apparatus size and costs can be reduced.

The distance measurement device 100 also includes a first control unit (illumination control unit) 31 and a second control unit (distance calculation unit) 32. The first control unit 31 controls illumination light emitted by the illumination unit 1, and the second control unit 32 acquires information (distance information) about a distance to a target object based on an output from the photodetector 22. The first control unit 31 is capable of changing illumination light into pulse light by, for example, controlling the light source and is also capable of generating signal light by modulating the intensity of illumination light. The second control unit 32 is capable of acquiring distance information about a target object based on the time from the time of emission of illumination light from the light source of the illumination unit 1 to the time of reception of light from the target object by the photodetector 22.

Alternatively, distance information may be acquired based on the phase of light from the target object instead of the time taken to receive light from the target object. Specifically, distance information about the target object may be acquired by calculating the difference in phase (phase difference) between a signal from the light source of the illumination unit 1 and a signal output from the photodetector 22 and multiplying the phase difference by the speed of light. In a case where the distance measurement device 100 is used in an environment with sufficient illumination light, such as sunlight, the distance measurement device 100 may be configured only with the light receiving unit 2 and the second control unit 32.

Distance measurement devices using LiDAR as described above are suitable for use in an on-board system that identifies moving devices, people, and obstacles as target objects and controls the moving device based on distance information about the target objects. A distance measurement device using LiDAR may use an axial system in which optical axes of an illumination unit and a light receiving unit match or a non-axial system in which optical axes of an illumination unit and a light receiving unit do not match. The optical system 21 according to the present exemplary embodiment is suitable for use especially in a non-axial system as illustrated in FIG. 10.

As described above, if the optical system 21 according to any one of the exemplary embodiments described above is applied to the distance measurement device 100, it is possible to acquire distance information about target objects with high accuracy even in a case where an infrared sensor with lower sensitivity than that of visible light sensors is used as the photodetector 22. The optical system 21 according to any one of the exemplary embodiments described above is also suitable for use in cases where the intensity of reflected light from a target object that reaches the photodetector 22 is weak, such as a case where the target object is at a great distance from the distance measurement device 100.

### [On-Board System]

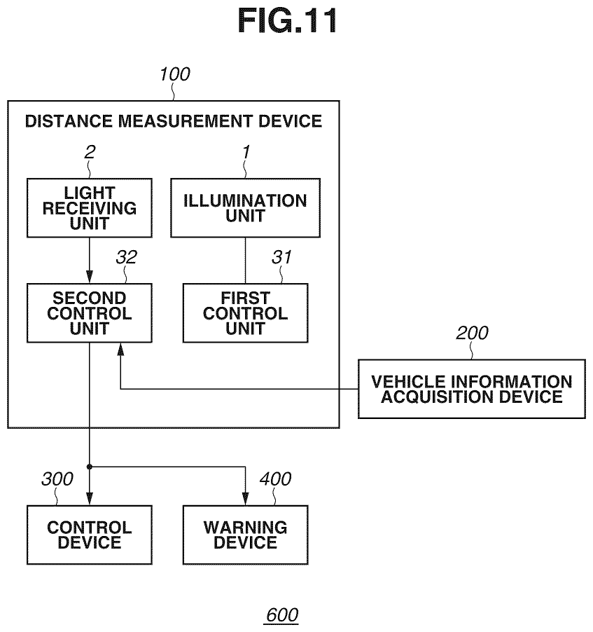

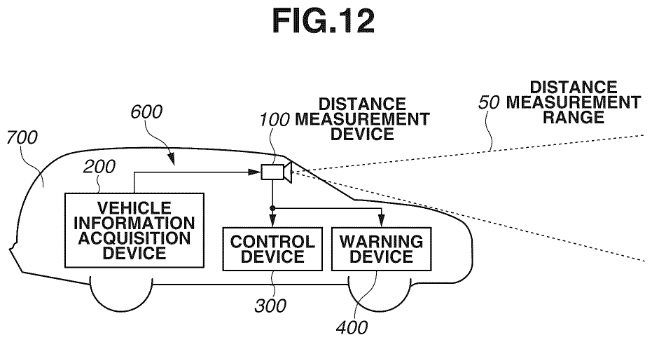

FIG. 11 is a diagram illustrating a configuration of the distance measurement device 100 according to the present exemplary embodiment and an on-board system (driving assistance apparatus, in-vehicle system) 600 including the distance measurement device 100. The on-board system 600 is an apparatus that is held by a movable object (moving device), such as an automobile (moving device, vehicle), and assists in the driving of the moving device based on distance information about target objects (obstacles) near the moving device that is acquired by the distance measurement device 100. FIG. 12 is a schematic diagram illustrating a moving device 700 including the on-board system 600. While FIG. 12 illustrates a case where a distance measurement range 50 of the distance measurement device 100 is set at the front of the moving device 700, the distance measurement range 50 may be set at the rear or side of the moving device 700.

As illustrated in FIG. 11, the on-board system 600 includes the distance measurement device 100, a moving device information acquisition device 200, a control device (electronic control unit (ECU)) 300, and a warning device 400. The distance measurement device 100 includes the illumination unit 1, the light receiving unit 2, the first control unit 31, and the second control unit 32. The second control unit 32 according to the present exemplary embodiment has the functions as the distance calculation unit and a collision determination unit.

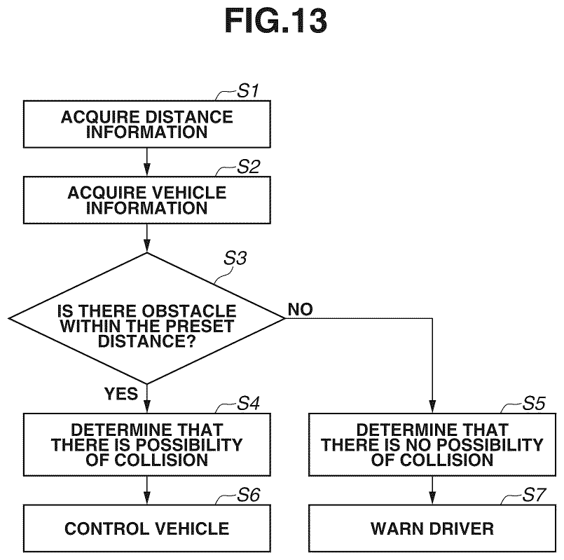

FIG. 13 is a flowchart illustrating an example of operations of the on-board system 600 according to the present exemplary embodiment. Operations of the on-board system 600 will be described below with reference to the flowchart.

In step S1, the illumination unit 1 illuminates target objects near the moving device 700, and the second control unit 32 acquires distance information about the target objects based on signals output by the light receiving unit 2 based on reflected light received from the target objects. In step S2, moving device information including a moving device speed, a yaw rate, and a steering angle of the moving device 700 is acquired from the moving device information acquisition device 200. In step S3, the second control unit 32 determines whether the distance information acquired in step S2 is within a preset distance range.

This makes it possible to determine whether there is an obstacle within the preset distance from the moving device 700 and determine the possibility of a collision between the moving device 700 and an obstacle. Steps S1 and S2 may be performed in the reverse order of the above-described order or may be performed in parallel. In a case where there is an obstacle within the preset distance (YES in step S3), in step S4, the second control unit 32 determines that “there is a possibility of a collision”, whereas in a case where there is no obstacle within the preset distance (NO in step S3), in step S5, the second control unit 32 determines that “there is no possibility of a collision”.

In the case where the second control unit 32 determines that “there is a possibility of a collision”, the second control unit 32 notifies this determination result to the control device 300 and the warning device 400. At this time, in step S6, the control device 300 controls the moving device 700 based on the determination result by the second control unit 32. In step S7, the warning device 400 warns the driver based on the determination result by the second control unit 32. The determination result is to be notified to at least one of the control device 300 and the warning device 400.

The control device 300 controls the moving device 700 to, for example, apply brakes, release an accelerator, or reduce engine and motor outputs by generating control signals for generating braking force on each wheel of the moving device 700. The warning device 400 warns a user (driver) of the moving device 700 by, for example, producing a warning sound, displaying warning information on a screen of a car navigation system, or vibrating a seat belt or a steering wheel.

As described above, the on-board system 600 according to the present exemplary embodiment is capable of detecting obstacles through the above-described process, thereby making it possible to avoid collisions between the moving device 700 and obstacles. By applying the optical system according to any one of the exemplary embodiments described above to the on-board system 600, high distance measurement accuracy is realized, and this makes it possible to perform obstacle detection and collision determination with high accuracy.

While the on-board system 600 is applied to driving assistance (collision damage reduction) according to the present exemplary embodiment, this is not a limitation. The on-board system 600 may be applied to cruise control (including full speed range adaptive cruise control) or autonomous driving. The on-board system 600 is also applicable to not only moving devices such as automobiles but also moving objects, such as ships, aircraft, and industrial robots. The on-board system 600 is also applicable to not only moving objects but also various devices that use object recognition, such as intelligent transportation systems (ITS) and monitoring systems.

The on-board system 600 or the moving device 700 may include a notification device (notification unit) so that in case of a collision between the moving device 700 and an obstacle, the collision is notified to the manufacturer of the on-board system 600 or the dealer of the moving device 700. For example, a notification device may be used configured to transmit information (collision information) about a collision between the moving device 700 and an obstacle to preset external notification destinations via email.

As described above, it is possible to proceed with inspection and repair promptly after a collision by using the notification device for automatically notifying collision information. The notification destinations of collision information may be any destinations set by the user, such as an insurance company, medical institution, and police. The notification device may also be configured to notify not only collision information but also failure information about components and consumption information about consumables to the notification destinations. The collision detection may be performed using the above-described distance information acquired based on the output from the light receiving unit 2 or may be performed by another detection unit (sensor).

### Modified Examples

While exemplary embodiments and examples of the present invention are described above, the present invention is not limited to the exemplary embodiments or the examples, and various combinations, modifications, and changes may be made within the scope of the present invention.

For example, while the stop is placed on the object side of the first lens in the optical system according to each exemplary embodiment, the position of the stop is not limited to that described above and may be placed, for example, between the first lens and the second lens. While object-side lens surfaces of the first lens, the second lens, and the third lens are aspherical surfaces in the optical system according to any one of the exemplary embodiments, another lens surface may be an aspherical surface as needed, or all lens surfaces may be spherical surfaces.

While the second control unit has the function as a collision determination unit (determination unit) according to the exemplary embodiments described above, this is not a limiting case. For example, the on-board system may include a collision determination unit separately from the second control unit. In other words, the second control unit is to have at least the function as a distance calculation unit (distance information acquisition unit). The first control unit and the second control unit may be provided outside the distance measurement device (e.g., in the moving device) as needed.

The present invention is not limited to the exemplary embodiments described above, and various changes and modifications can be made without departing from the spirit and scope of the present invention. The claims below are attached to disclose the scope of the present invention.

The present invention provides an optical system that has a sufficiently small f-number and is capable of correcting various aberrations effectively, a distance measurement device including the optical system, and an on-board system.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An optical system comprising, in order from an object side to an image side:
a first lens with positive refractive power;
a second lens with negative refractive power; and
a third lens with positive refractive power,
wherein at least one of the first lens and the third lens is made of chalcogenide material, and the second lens is made of glass material, and
wherein the following inequality is satisfied:
$$0.75 < Np - Nn ,$$
where Np is a refractive index of the lens made of the chalcogenide material at a wavelength of 0.9 μm, and Nn is a refractive index of the second lens at a wavelength of 0.9 μm.

2. The optical system according to claim 1, wherein the following inequality is satisfied:
$$0.75 < Np - Nn < 1.45 .$$

3. The optical system according to claim 1, wherein the following inequality is satisfied:
$$- 3. < f 1 / f 2 < - 1. ,$$
where f1 is a focal length of the first lens, and f2 is a focal length of the second lens.

4. The optical system according to claim 1, wherein the following inequality is satisfied:
$$- 3. < f 2 / fr < - 0.5 ,$$
where f2 is a focal length of the second lens, and fr is a combined focal length of a lens or lenses closer to an image than the second lens is.

5. The optical system according to claim 1, wherein the following inequality is satisfied:
$$0.1 < fr / f 1 < 1. ,$$
where f1 is a focal length of the first lens, and fr is a combined focal length of a lens or lenses placed closer to an image than the second lens is.

6. The optical system according to claim 1, wherein the following inequality is satisfied:
$$0.1 < f 1 / f < 3. ,$$
where f1 is a focal length of the first lens, and f is a focal length of the optical system.

7. The optical system according to claim 1, wherein the following inequality is satisfied:
$$- 3. < f 2 / f < - 0.1 ,$$
where f2 is a focal length of the second lens, and f is a focal length of the optical system.

8. The optical system according to claim 1, wherein the following inequality is satisfied:
$$0.1 < fr / f < 2. ,$$
where fr is a combined focal length of a lens or lenses placed closer to an image than the second lens is, and f is a focal length of the optical system.

9. The optical system according to claim 1, wherein the following inequality is satisfied:
$$0.6 < Fno < 1. ,$$
where Fno is an f-number of the optical system.

10. The optical system according to claim 1, wherein the first lens is made of chalcogenide material.

11. The optical system according to claim 10, wherein the third lens is made of chalcogenide material.

12. The optical system according to claim 1, wherein a stop is placed on the object side of the first lens.

13. An image capturing apparatus comprising:
the optical system according to claim 1; and
a photodetector configured to receive an image of an object that is formed by the optical system.

14. A distance measurement device comprising:
the image capturing apparatus according to claim 13; and
a control unit configured to acquire distance information about the object based on an output from the photodetector.

15. An on-board system comprising:
the distance measurement device according to claim 14; and
a determination unit configured to determine whether there is a possibility of a collision between a moving device and the object based on the distance information about the object that is acquired by the distance measurement device.

16. The on-board system according to claim 15, further comprising a control device configured to output a control signal for causing wheels of the moving device to generate braking force in a case where it is determined that there is the possibility of the collision between the moving device and the object.

17. The on-board system according to claim 15, further comprising a warning device configured to warn a driver of the moving device in a case where it is determined that there is the possibility of the collision between the moving device and the object.

18. The on-board system according to claim 15, further comprising a notification device configured to notify information about the collision between the moving device and the object to an external destination.

19. A moving device comprising the image capturing apparatus according to claim 13 and configured to move while holding the image capturing apparatus.

20. The moving device according to claim 19, further comprising a determination unit configured to determine whether there is a possibility of a collision with the object based on distance information about the object that is acquired by the image capturing apparatus.
